(19) United States
(12) Patent Application Publication
(10) Pub. No.: US 2017/0184053 A1
(43) Pub. Date: Jun. 29, 2017

(54) GAS TURBINE ENGINE VANE SPLITTER

(71) Applicant: ROLLS-ROYCE plc, London (GB)

(72) Inventors: Neil W. HARVEY, Derby (GB); Rosario SPATARO, Cambridge (GB); Robert J. MILLER, Cambridge (GB); Ivor J. DAY, Cambridge (GB)

(73) Assignee: ROLLS-ROYCE plc, London (GB)

(21) Appl. No.: 15/379,851

(22) Filed: Dec. 15, 2016

(30) Foreign Application Priority Data
Dec. 23, 2015 (GB) 1522718.4

(51) Int. Cl. F02K 1/82

(52) U.S. Cl. CPC F02K 1/82

(57) ABSTRACT

A gas turbine engine duct turns radially inwardly in the downstream direction. The duct includes a plurality of radially extending stator vanes. A generally circumferentially extending splitter vane is provided between two circumferentially neighbouring stator vanes. The splitter vane improves the flow near to the radially inner wall of the duct. This can allow greater design freedom in the duct geometry.

### CROSS-REFERENCE TO RELATED APPLICATIONS

This application is based upon and claims the benefit of priority from British Patent Application Number 1522718.4 filed 23 Dec. 2015, the entire contents of which are incorporated by reference.

### BACKGROUND

1. Field of the Disclosure

The present disclosure relates to a flow splitter, for example a flow splitter in a duct of a gas turbine engine.

2. Description of the Related Art

A gas turbine engine comprises one or more annular flow paths, such as a bypass flow path (in the case of a turbofan gas turbine engine) and a core flow path. The core flow path typically passes through a compressor section, a combustor, and a turbine section. The radius of an annular flow path may vary along the flow path, for example along a generally axial direction.

For example, a typical compressor section comprises one or more regions in which the radius of the annular flow path (for example the mean radius) decreases along the flow direction. Such a flow path may be formed between a radially inner hub and a radially outer core casing and may comprise stator vanes extending in a generally radial direction. Examples of such flow regions are in the core flow entry region, which may be immediately downstream of the fan of a turbofan engine, and in a transition duct between two compressors of different mean radii, for example between an intermediate pressure compressor and a high pressure compressor.

In such a duct, the flow in the region adjacent the radially inner hub may experience a higher streamwise increase in pressure than the flow in the rest of the flow passage, for example due to the change in curvature as the hub initially curves radially inwardly (thereby reducing the static pressure adjacent the wall) and then straightens (thereby increasing the static pressure adjacent the wall).

This high increase in pressure adjacent the hub may constrain the design of the flow path, or duct, to be such that the boundary layer does not separate in this region. This may mean that, for example, the axial length of the duct may need to be greater than desired for a given reduction in radius of the flow path. In turn, this may lead to a longer, heavier engine.

Even if the duct is designed such that the boundary layer adjacent the hub wall does not separate under normal operating conditions, the flow rate adjacent the wall may still be less than that through the rest of the passage. In turn, this may mean that this flow in the region adjacent the hub wall cannot be worked so hard (for example cannot be compressed so much) as the rest of the flow in the passage, for example by the rotor blades. This may lead to reduced engine efficiency or stability at certain points in the engine operating range.

### OBJECTS AND SUMMARY

Accordingly, it would be desirable to be able to reduce the design constraints on the ducts within a gas turbine engine.

According to an aspect, there is provided a gas turbine engine duct comprising a radially inner wall and a radially outer wall formed around an axial direction (which may be referred to as the rotational axis of the engine) so as to form a generally annular flow passage. A plurality of circumferentially spaced stator vanes extend across the annular flow passage from the radially inner wall to the radially outer wall. A splitter vane is provided that extends in a generally circumferential direction between two circumferentially adjacent stator vanes, the splitter vane having a leading edge and a trailing edge. The trailing edge of the splitter vane may be said to be axially downstream of the leading edge.

The radius of the radially inner wall may decrease with increasing axial position in a downstream direction of the duct. Alternatively, in some arrangements, the radius of the radially inner wall may remain constant or increase with increasing axial position in a downstream direction of the duct.

The radius of the radially outer wall may decrease with increasing axial position in a downstream direction of the duct. Alternatively, in some arrangements, the radius of the radially outer wall may remain constant or increase with increasing axial position in a downstream direction of the duct.

The splitter vane may improve the flow in the duct. For example, the presence of the splitter vane may result in more even flow distribution (for example in terms of pressure and/or velocity) across the radius of the duct downstream of the splitter vane and/or may increase the flow velocity in the region of the inner wall downstream of the splitter vane and/or reduce the susceptibility to boundary layer separation downstream of the splitter vane. The splitter vane may be referred to as a flow control device.

The splitter vane may allow greater freedom in the design of the duct. Purely by way of example, the presence of the splitter vane may allow the radius of the duct (for example the midpoint between the inner and outer surfaces) to decrease more over a given axial extent and/or may allow the flow area to increase more rapidly through the duct (for example a greater increase in flow area over a given axial extent).

The splitter vane may result in a gas turbine engine with improved efficiency (for example better specific fuel consumption) and/or lower weight and/or reduced size compared with a gas turbine engine that does not comprise a splitter vane.

The duct and/or the inner wall and/or the outer wall may be axisymmetric. The midpoint between the radially inner wall and the radially outer wall may be said to move radially inwards with increasing distance along the duct (that is, in a downstream direction and/or with increasing axial distance). In use, the streamlines through the duct may be said to move radially inwards in the flow direction.

The splitter vane may be attached to and/or integral with one or more (for example two circumferentially adjacent) stator vanes. The splitter vane may be supported only by one or more stator vanes, for example the splitter vane may, in some arrangements, have no support other than one or more stator vanes. The stator vanes may have a suction surface and a pressure surface. The splitter vane may be attached and/or integral with the suction surface of one stator vane and/or the pressure surface of a circumferentially adjacent stator vane.

The spanwise direction of the stator vanes may be generally radial. The spanwise direction of the splitter vane may be generally circumferential. The splitter vafie and the stator vanes (for example the spanwise directions thereof) may be said to be generally perpendicular to each other.

The stator vanes and/or the splitter vane(s) may only extend over a portion of the duct in an axial and/or streamwise direction. For example, the stator vanes and/or the splitter vane(s) may only extend over an upstream portion of the duct in an axial and/or streamwise direction. By way of further example, the stator vanes and/or the splitter vane(s) may only extend over a portion of the duct that is upstream (or axially before) the position of maximum mean curvature of the duct.

The flow area of the duct may increase in a streamwise (and/or an axially downstream) direction.

The splitter vane may be an aerofoil shape. The radially outer surface of the splitter vane may be a suction surface. The radially inner surface of the splitter vane may be a pressure surface. The splitter vane may be cambered.

The stator vanes may be turning vanes. For example, the stator vanes may turn the flow relative to the direction that the flow would take in the absence of the stator vanes. The stator vanes may be referred to as lifting vanes. The stator vanes may have a pressure surface and a suction surface. The stator vanes may turn the flow in a substantially circumferential direction. The stator vanes may be cambered.

The gas turbine engine duct may comprise one or more than one splitter vane. For example, the duct may comprise a plurality of splitter vanes. Each pair of circumferentially adjacent stator vanes may have a splitter vane provided therebetween. Where more than one splitter vane is provided, each splitter vane may be the same. Where reference is made herein to a splitter vane, this may mean one or more splitter vanes, for example all splitter vanes. Where more than one splitter vane is provided, each splitter vane may be offset from the others in a circumferential direction.

The ratio of the distance between the radially inner wall and the splitter vane to the distance between the radially outer wall and the splitter vane may be greater at the leading edge than at the trailing edge of the splitter vane. The splitter vane may be proportionally (and/or absolutely) closer to the radially inner wall at its trailing edge than at its leading edge.

The leading edge of the splitter vane may be at any desired radial position. For example, the leading edge of the splitter vane may be no closer to the radially outer wall than it is to the radially inner wall. For example, the leading edge of the splitter vane may be less than 40%—for example less than 30%, for example less than 25%, for example less than 15%, for example less than 10%—of the total distance between the radially inner wall and the radially outer wall from the radially inner wall.

The distance between the radially inner wall and the trailing edge of the splitter may be in the range of from 2% to 30%, for example 5% to 20%, for example more than 10% to 15%, of the distance between the radially inner wall and the radially outer wall.

An inlet flow area may be defined by the radially inner wall, the splitter vane leading edge, and the two circumferentially adjacent stator vanes between which the splitter vane extends. An outlet flow area may defined by the radially inner wall, the splitter vane trailing edge, and the two circumferentially adjacent stator vanes between which the splitter vane extends. The ratio of the exit flow area to the inlet flow area may be less than or equal to one. The ratio of the inlet flow area to the total flow area of the passage at the leading edge of the splitter vane may be greater than the ratio of the outlet flow area to the total flow area at the trailing edge of the splitter vane.

The flow area between the splitter vane and the radially inner wall at the leading edge of the splitter vane may be greater than the flow area between the splitter vane and the radially inner wall at the trailing edge of the splitter vane. Regardless of whether or not this flow area is greater at the leading edge than at the trailing edge, the proportion of the total flow area of the flow passage that is between the splitter vane and the radially inner wall may be greater at the leading edge than at the trailing edge.

The flow area may, for example, be taken perpendicular to the streamlines and/or local flow direction at a given location.

A throat may be defined by circumferentially adjacent stator vanes. Such a throat may be the narrowest flow area in the flow passage between two circumferentially adjacent stator vanes. The leading edge of the splitter vane may be downstream of the throat. The leading edge of the splitter vane may be said to be axially rearward of the throat. For example, in a turbofan engine, the leading edge of the splitter vane may be on the opposite side of the throat to that side on which the fan is positioned.

The splitter vane may be in any desired position relative to the stator vanes. For example, the trailing edge of the splitter vane may be not further downstream than a trailing edge of the stator vanes, for example at least where the trailing edges meet. However, in other arrangements, the trailing edge of the splitter vane may be downstream of the trailing edge of the stator vane.

The splitter vane may be shaped to turn the flow through the gas turbine engine (for example the flow in the duct) radially inwardly during use. The splitter vane may be shaped to turn the flow through the gas turbine engine (for example the flow in the duct) radially inwardly during use in absolute terms and/or relative to the flow direction in the absence of the splitter vane. The splitter vane may be a lifting aerofoil.

The splitter vane may be of any suitable construction. In some arrangements, The splitter vane may not be structural. The sole purpose of the splitter vane may be aerodynamic in some arrangements. The structure of the splitter vane may be such that it can support only aerodynamic loads, for example only aerodynamic loads that are generated by itself or by adjacent (or nearby) surfaces.

The cross-sectional profile of the splitter vane may take any suitable form. For example, the cross-section of the splitter vane perpendicular to the spanwise direction may be constant or may vary along the span. The splitter vane may have an aerofoil section/profile that is constant along its span or an aerofoil section/profile that varies along the span. The spanwise direction may be generally circumferential.

Any one or more of the following may be constant or may vary along the span of the splitter vane: the camber; the chord length; the axial leading edge position; the axial trailing edge position; the thickness; the distance of the leading edge from the hub; the distance of the trailing edge from the hub; the thickness (or thickness distribution). The stacking axis of the splitter vane may be circumferential or may have an axial and/or radial component along with a circumferential component. The major axis of the splitter vane may be in a circumferential direction.

The leading edge of the splitter vane may have a waved and/or serrated shape. The trailing edge of the splitter vane may have a waved and/or serrated shape. The waves and/or serrations may be in a radial and/or an axial direction.

In general, the splitter vane may reduce the overall noise of the flow (and/or may be used to tailor the noise signature as desired). Use of a waved and/or serrated shape on the leading or trailing edge may be particularly advantageous in controlling the flow noise.

The splitter vane may comprise other features that may be used with aerofoils. For example, the splitter vane may comprise one or more vortex generators. By way of further example, such a vortex generator may comprise more than one element, for example it may have a slat and/or a flap.

The splitter vane may extend continuously across the full passage (or circumferential gap) between the neighbouring stator vanes and/or may be attached and/or integral with both of the neighbouring stator vanes. Alternatively, a splitter vane may extend only partially across the circumferential gap between neighbouring stator vanes. Such a splitter vane may only be attached to one stator vane. Such a splitter vane may be referred to as a cantilevered splitter vane. Such a splitter vane may extend half or less than half of the circumferential gap between neighbouring stator vanes. Neighbouring stator vanes may have respective splitter vanes extending therefrom towards each other. A circumferential gap may be left between splitter vanes extending towards each other from neighbouring stator vanes. As noted elsewhere herein, the splitter vane(s) may extend in a substantially circumferential direction.

According to an aspect, there is provided a gas turbine engine comprising a gas turbine engine duct as described and/or claimed herein, for example including a splitter vane as described and/or claimed herein.

According to an aspect, there is provided a gas turbine engine comprising a fan stage; and an engine core downstream of the fan stage. The gas turbine engine (for example the core thereof) comprises a gas turbine engine duct as described and/or claimed herein, for example including a splitter vane as described and/or claimed herein. The plurality of circumferentially spaced stator vanes may be provided immediately downstream of the fan stage.

According to an aspect, there is provided a gas turbine engine comprising: a fan stage; and an engine core downstream of the fan stage, the core having a plurality of circumferentially spaced stator vanes immediately downstream of the fan stage, wherein: a splitter vane is provided between two of the stator vanes, the splitter vane having a leading edge and a trailing edge. The stator vanes and/or splitter vanes may be as described and/or claimed herein, for example they may be provided in a duct within the gas turbine engine as described and/or claimed herein.

In a gas turbine engine, the splitter vane(s) may be provided immediately downstream of the fan stage. Immediately downstream may mean that there are no intermediate aerodynamic features, such as blades or vanes, in the flow path.

The radially inner wall of the gas turbine engine duct may be a hub. The radially outer wall of the gas turbine engine duct may be a core casing.

In a gas turbine engine, the circumferentially spaced stator vanes may be immediately upstream of circumferentially spaced guide vanes, which may be referred to as non-rotating guide vanes in the sense that they do not rotate about the axial direction (rotational axis) of the engine. The circumferentially spaced non-rotating guide vanes may be variable inlet guide vanes whose angle may be varied about a radial axis. Alternatively, the circumferentially spaced stator vanes may be immediately upstream of rotor blades.

The skilled person will appreciate that except where mutually exclusive, a feature described in relation to any one of the above aspects may be applied to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a schematic side view of a gas turbine engine duct;

FIG. 3 is a view looking in a downstream direction along a gas turbine engine duct;

FIG. 4 is a view looking in an upstream direction along a gas turbine engine duct;

FIG. 5 is a schematic view along a substantially radial direction showing a splitter vane between two stator vanes;

FIG. 6 is a schematic view along a substantially radial direction showing a splitter vane between two stator vanes;

FIG. 7 is a schematic view along a substantially radial direction showing a splitter vane between two stator vanes;

FIG. 8 is a schematic view along a substantially radial direction showing a splitter vane between two stator vanes;

FIG. 9 is a schematic view along a substantially radial direction showing a splitter vane between two stator vanes;

FIG. 10 is a schematic view along a substantially radial direction showing two splitter vanes between two stator vanes;

FIG. 11 is a schematic view looking at a trailing edge of a splitter vane;

FIG. 12 is a schematic side view of a flapped splitter vane;

FIGS. 13A to 13F are schematic views showing example of possible stacking axes of a splitter vane;

FIG. 14 is a schematic side view of a twisted splitter vane; and

FIG. 15 is a schematic view showing a part of a splitter vane having variable thickness along its span.

### DETAILED DESCRIPTION OF EMBODIMENTS

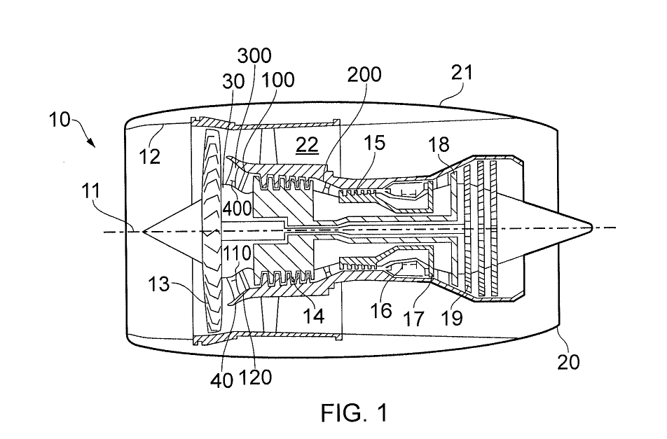

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The gas turbine engine 10 comprises a number of generally annular ducts, any one or more of which may be in accordance with aspects of the present disclosure. For example, a duct 100 is provided immediately downstream of the fan 13, between the fan 13 (which may be an example of a low pressure compressor) and the intermediate pressure compressor 14. The duct 100 is defined by a radially inner wall 110 (formed by a hub 30) and a radially outer wall 120 (formed by a core casing 40). The duct 100 is provided with (and thus may be said to comprise) a plurality of stator vanes 300. A splitter vane 400 is provided between at least two of the circumferentially spaced stator vanes 300. The duct 100, including the stator vanes 300 and splitter vane(s) 400, are described in greater detail below in relation to the subsequent Figures.

A further example of a duct 200 that may be in accordance with the present disclosure is the duct labelled 200 in FIG. 1, between the intermediate pressure compressor 14 and the high pressure compressor 15. Indeed, and purely by way of example, a duct in accordance with the present disclosure may be formed anywhere in the engine 10, for example within or between any of the fan, compressor, combustor or turbine sections, for example between any two compressor sections. Any one of the ducts in the gas turbine engine may be in accordance with the present disclosure, and may comprise at least one stator vane 300 and at least one splitter vane 400.

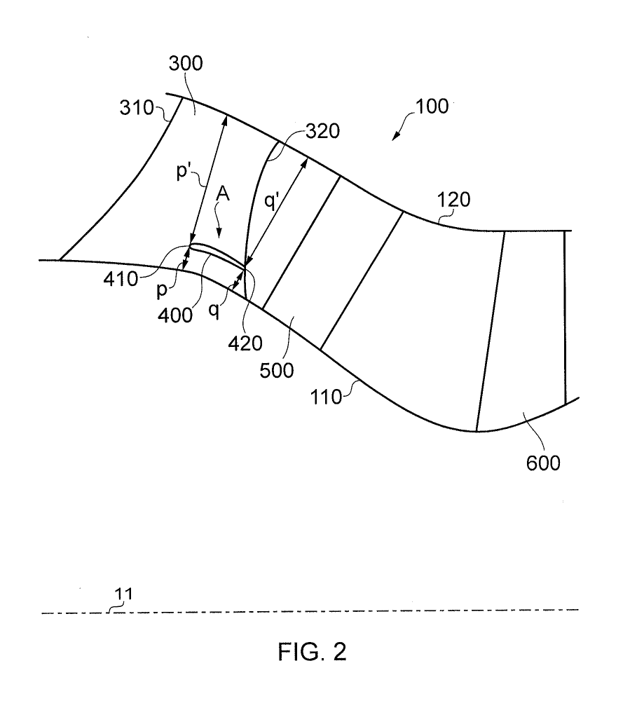

FIG. 2 shows the exemplary duct 100 in greater detail. The stator vanes 300 extend between the radially inner wall 110 and the radially outer wall 120. The stator vanes 300 may have an aerodynamic and structural function, as in the FIG. 2 example. At least part of the structural function may be to transmit load between the hub 30 and the core casing 40. The stator vanes 300 may be referred to as engine section stators (ESS).

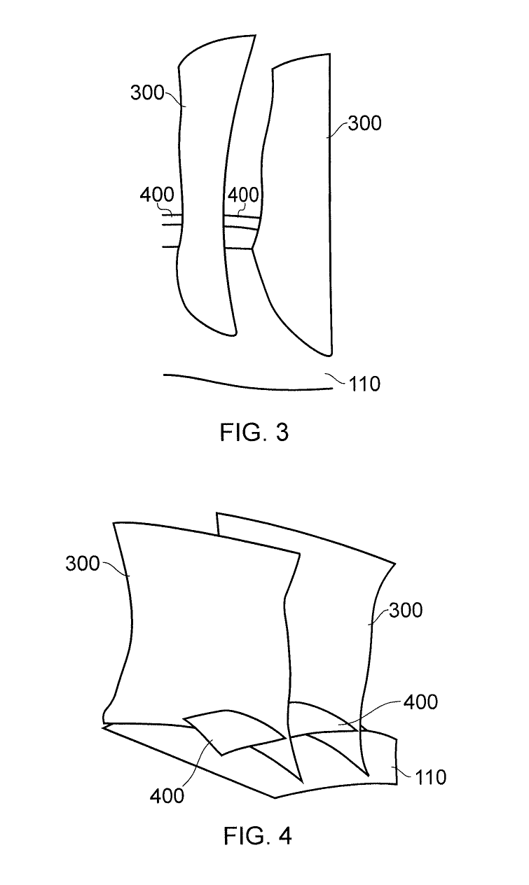

The splitter vane 400 extends in a generally circumferential direction (into and out of the page in FIG. 2) between two circumferentially neighbouring stator vanes 300. This is shown clearly in FIG. 3 (which is a view from an upstream direction, i.e. looking in a downstream direction) and FIG. 4 (which is a view from a downstream direction, i.e. looking in an upstream direction). The splitter vane 400 extends axially from a leading edge 410 to a trailing edge 420. The leading edge 410 is axially upstream (towards the fan 13) of the trailing edge 420.

The splitter vane 400 may have an aerofoil profile, as in the illustrated example. The splitter vane 400 may be a turning element. The splitter vane 400 may be arranged (for example shaped and/or positioned and/or oriented) to turn the flow in a radially inward direction, indicated by arrow A in FIG. 2. Such radially inward flow turning may be relative to the flow direction that would exist in the absence of the splitter vane 400.

The distance p between the radially inner wall 110 and the leading edge 410 of the splitter vane 400 may be greater than distance q between the radially inner wall 110 and the trailing edge 420 of the splitter vane 400, in absolute terms and/or as a proportion of the total distance at inlet (p+p′) and outlet (q+q′). The inlet flow area defined at least in part by the radially inner wall 110 and the leading edge 410 of the splitter vane 400 may be greater than the outlet flow area defined at least in part by the radially inner wall 110 and the trailing edge 420 of the splitter vane 400—again in absolute terms and/or as a proportion of the total flow areas at inlet and outlet.

In the arrangement sown in FIGS. 2 to 4, the trailing edge 420 of the splitter vane 400 is at the same axial position at as the trailing edge 320 of the stator vane 400, at least at the radial position where the splitter vane 400 meets the trailing edge 320 of the stator vane 300. However, this need not be the case, and the trailing edge 420 of the splitter vane 400 may alternatively be upstream or downstream of the trailing edge 320 of the stator vane 300. Indeed, as discussed elsewhere herein, the splitter vane 400 may take many different forms, including shape and/or position and/or orientation.

In the FIG. 2 arrangement, a stationary guide vane 500 (which may be a variable inlet guide vane) is provided immediately downstream of the stator vanes 300 and splitter vane(s) 400. The guide vane 500 may be said to be a part of the duct 100. Immediately downstream of the guide vane 500 is a rotor blade 600, which is the first blade of the intermediate pressure compressor 14, in the FIG. 2 example. However, it will be appreciated that other arrangements of upstream and/or downstream blades and/or vanes are possible, and that the arrangement shown in FIG. 2 is by way of example only.

The presence of the splitter vane 400 may improve the flow characteristics in the duct 100. For example, the splitter vane 400 may help the flow to stay attached to the inner wall 110 in the region of and/or downstream of the splitter vane 400. By way of further example, the splitter vane 400 may help to provide a more even flow distribution (in terms of pressure and/or velocity for example) across the radial extent of the duct 100.

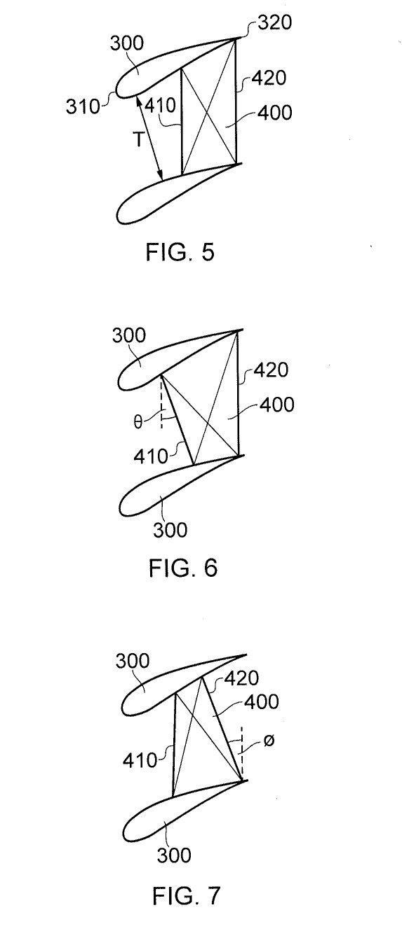

The splitter vane(s) 400 may have any suitable configuration, for example any suitable shape and/or size and/or position. Examples of possible splitter vanes 400 are shown in FIGS. 5 to 15 and described below.

A throat T may be formed between circumferentially adjacent stator vanes 300, as illustrated in the FIG. 5 example. The throat T may be defined as being at the minimum flow area between the two circumferentially adjacent stator vanes 300 in the duct 100. As shown in the FIG. 5 example, the leading edge 410 of the splitter vanes 400 may be downstream of the throat T. For example, the leading edge 410 of a splitter vane 400 may be downstream of the throat T of the stator vanes 300 across the entire span of the splitter vane 400. In other arrangements, the leading edge 410 of a splitter vane 400 may be upstream of the throat T, or at the same axial location as the throat T.

The leading edge 410 of the splitter vane 400 may take any suitable shape. For example, as illustrated in FIG. 6, when viewed from a radial direction the leading edge may be angled θ relative to the circumferential direction, either in the axially forwards direction with increasing distance from the pressure surface of the stator vane 300 to which it is attached, or (as in the FIG. 6 example) in the axially rearward direction with increasing distance from the pressure surface of the stator vane 300 to which it is attached. In such arrangements, the axial position of the leading edge 410 of the splitter vane 400 may be said to vary along its span and/or in a circumferential direction. Alternatively, of course, the axial position of the leading edge 410 of the splitter vane 400 may be constant along its span.

The trailing edge 420 of the splitter vane 400 may take any suitable shape. For example, as illustrated in FIG. 7, when viewed from a radial direction the trailing edge may be angled ø relative to the circumferential direction, either in the axially forwards direction with increasing distance from the pressure surface of the stator vane 300 to which it is attached, or (as in the FIG. 7 example) in the axially rearward direction with increasing distance from the pressure surface of the stator vane 300 to which it is attached. In such arrangements, the axial position of the trailing edge 420 of the splitter vane 400 may be said to vary along its span and/or in a circumferential direction. Alternatively, of course, the axial position of the trailing edge 420 of the splitter vane 400 may be constant along its span.

The leading edge 410 and/or the trailing edge 420 of the splitter vane 400 may be provided with protuberances. Such protuberances may provide improved aerodynamic performance and/or improved acoustic performance (for example attenuating longitudinal and/or azimuthal and/or radial mode disturbances).

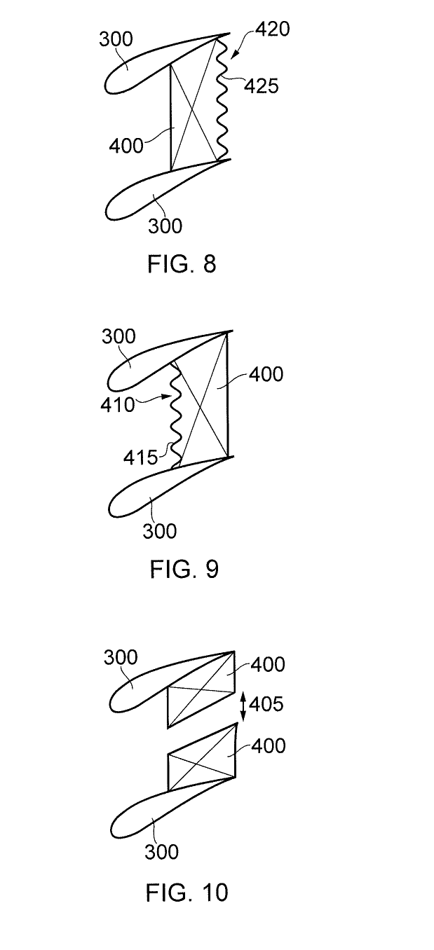

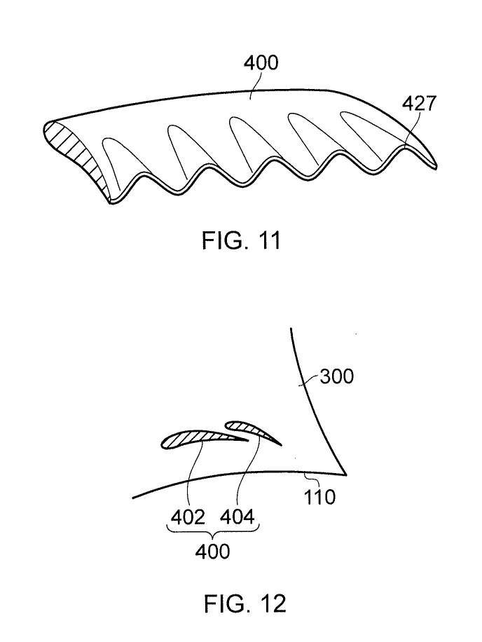

With regard to the trailing edge 420, for example, FIG. 8 shows an example of a splitter vane 400 in which the trailing edge 420 has a waved shape 425. The trailing edge 420 may be serrated. The protuberances, waves or serrations may be provided in any direction, for example in an axial direction (as in the FIG. 8 example), and/or in the radial direction. Purely by way of further example, FIG. 11 shows an arrangement in which the trailing edge 420 of the splitter vane 400 has a waved shape in which the waved profile 427 is provided in the radial direction.

With regard to the leading edge 410, for example, FIG. 9 shows an example of a splitter vane 400 in which the leading edge 410 has a waved shape 415. The leading edge 410 may be serrated. The protuberances, waves or serrations may be provided in any direction, for example in an axial direction (as in the FIG. 9 example), and/or in the radial direction.

A splitter vane 400 may extend fully across the circumferential gap between two stator vanes 300. Alternatively, as in the FIG. 10 example, a splitter vane 400 may extend only across a part of the gap between two stator vanes 300. The FIG. 10 example shows a stator vane 400 that extends across less than half of the gap between two stator vanes 300. In this example, two splitter vanes 300 are provided in the circumferential gap between two circumferentially neighbouring stator vanes 300, one of which is attached to the pressure surface of one stator vane 300, with the other attached to the suction surface of a circumferentially neighbouring stator vane 300. Each splitter vane 400 extends across less than half of the circumferential gap between the stator vanes 300, such that a circumferential gap 405 is left between the splitter vanes 400.

A splitter vane 400 may be provided as a single element or as multiple elements. For example, the splitter vane 400 may have a main element and a slat and/or flap, at the leading edge of the main element and/or at the trailing edge of the main element. Purely by way of example, FIG. 12, which is a schematic showing a cross-section through a splitter vane 400 perpendicular to a circumferential direction, illustrates a splitter vane 400 comprising a main element 402 together with a flap 404.

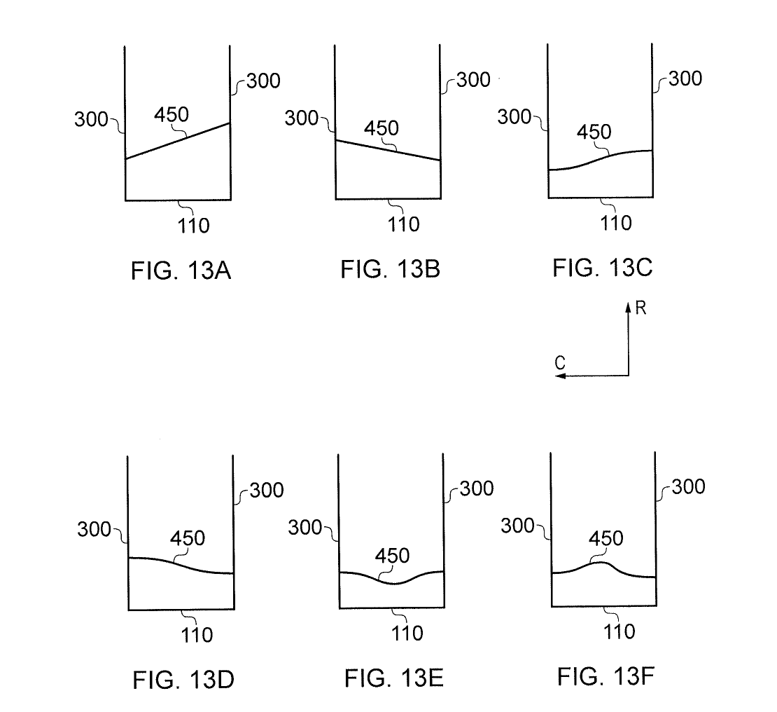

The splitter vane 400 may have a stacking axis that may take any desired shape. The stacking axis may be defined as a line passing through the centroids of all of the cross-sections of the splitter vane. FIGS. 13A to 13F (which may be referred to collectively as FIG. 13) show, purely by way of example, possible stacking axes 450. FIG. 13 is a schematic representation in the radial (R)-circumferential (C) plane, with a circumferentially extending inner wall 110 thus shown by a straight line perpendicular to the radially extending stator vanes 300. Thus, in FIG. 13, a stacking axis 450 with no radial component (for example a purely circumferential stacking axis 450) would be represented by a straight line parallel to the hub wall 110. Such a stacking axis 450 is, of course, possible, although not represented in FIG. 13, which shows alternative examples. In FIG. 13, the line labelled 300 to the left of each example may represent the suction surface of one stator vane 300. The line labelled 300 to the right of each example may represent the pressure surface of a circumferentially adjacent stator vane 300.

FIG. 13A shows a stacking axis 450 that moves linearly radially outboard away from the left hand stator vane 300 to the right hand stator vane 300. FIG. 13C is a variation on FIG. 13A, in which the radial movement is not linear with circumferential position. FIG. 13B shows a stacking axis 450 that moves radially inboard away from the left hand stator vane 300 to the right hand stator vane 300. FIG. 13D is a variation on FIG. 13A, in which the radial movement is not linear with circumferential position. FIG. 13E shows a stacking axis 450 which has its most radially inner position at a location away from the stator vanes 300, for example substantially in the middle of the circumferential gap between the two stator vanes 300. FIG. 13F shows a stacking axis 450 which has its most radially outer position at a location away from the stator vanes 300, for example substantially in the middle of the circumferential gap between the two stator vanes 300.

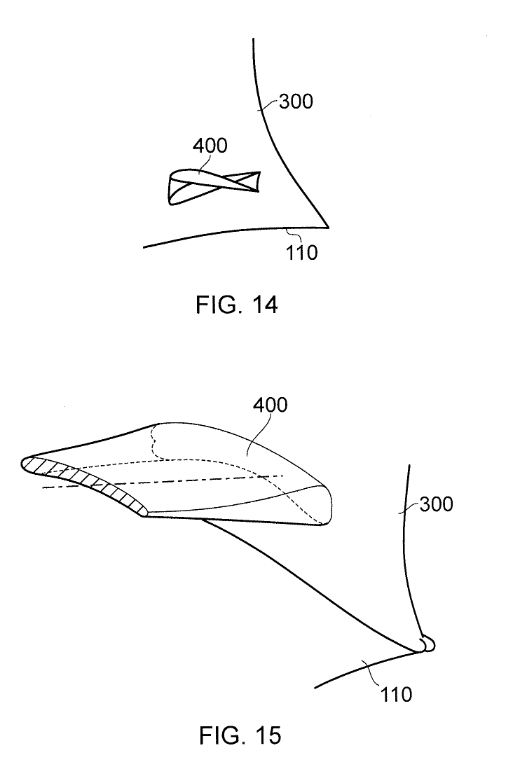

FIG. 14 is a side view looking along a circumferential direction at an example of a splitter vane 400 that has a twisted profile. Such a splitter vane 400 may be twisted so as to have cross-sectional profiles with chord lines that are angled relative to each other in any desired manner. For example, the angle of the chord line of the splitter vane cross-sections to the axial direction may change along the span of the splitter vane 400 in any desired manner.

The thickness of the splitter vane 400 may vary along its span, or may be constant. By way of example, FIG. 15 shows a splitter vane 400 that has reducing thickness with increasing circumferential distance from the stator vane 300, although other thickness distributions are possible, of course.

The splitter vane 400 described and/or claimed herein may be provided in any suitable position, for example in any duct of a gas turbine engine including, by way of example, the duct 100 and/or the duct 200 shown in FIG. 1 and described above.

It will be understood that the invention is not limited to the embodiments above-described and various modifications and improvements can be made without departing from the concepts described herein. Purely by way of example, the gas turbine engine duct described and/or claimed herein may be (for example) a part of a turbine or a part of a compressor of a gas turbine engine. Except where mutually exclusive, any of the features may be employed separately or in combination with any other features and the disclosure extends to and includes all combinations and sub-combinations of one or more features described herein.

1. A gas turbine engine duct comprising a radially inner wall and a radially outer wall formed around an axial direction so as to form a generally annular flow passage, wherein
a plurality of circumferentially spaced stator vanes extend across the annular flow passage from the radially inner wall to the radially outer wall; and
a splitter vane is provided that extends in a generally circumferential direction between two circumferentially adjacent stator vanes, the splitter vane having a leading edge and a trailing edge.

2. A gas turbine engine duct according to claim 1, wherein the radius of the radially inner wall decreases with increasing axial position in a downstream direction of the duct.

3. A gas turbine engine according to claiml, wherein the radius of the radially outer wall decreases with increasing axial position in a downstream direction of the duct.

4. A gas turbine engine duct according to claim 1, wherein:
the splitter vane is one of a plurality of splitter vanes, with each pair of circumferentially adjacent stator vanes having a splitter vane provided therebetween.

5. A gas turbine engine duct according to claim 1, wherein:
the ratio of the distance between the radially inner wall and the splitter vane to the distance between the radially outer wall and the splitter vane is greater at the leading edge than at the trailing edge of the splitter vane.

6. A gas turbine engine duct according to claim 1, wherein the leading edge of the splitter vane is no closer to the radially outer wall than it is to the radially inner wall.

7. A gas turbine engine duct according to claim 1, wherein the distance between the radially inner wall and the trailing edge of the splitter is more than 5% of the distance between the radially inner wall and the radially outer wall.

8. A gas turbine engine duct according to claim 1, wherein:
an inlet flow area is defined by the radially inner wall, the splitter vane leading edge, and the two circumferentially adjacent stator vanes between which the splitter vane extends;
an outlet flow area is defined by the radially inner wall, the splitter vane trailing edge, and the two circumferentially adjacent stator vanes between which the splitter vane extends; and
the ratio of the exit flow area to the inlet flow area is less than or equal to one.

9. A gas turbine engine duct according to claim 1, wherein:
circumferentially adjacent stator vanes define a throat; and
the leading edge of the splitter vane is downstream of the throat.

10. A gas turbine engine duct according to claim 1, wherein:
the stator vanes have a trailing edge; and
the trailing edge of the splitter vane is not further downstream than the trailing edge of the stator vanes.

11. A gas turbine engine duct according to claim 1, wherein:
the splitter vane is shaped to turn the flow through the gas turbine engine radially inwardly during use.

12. A gas turbine engine duct according to claim 1, wherein the cross-sectional profile of the splitter vane perpendicular to the spanwise direction varies along the span.

13. A gas turbine engine duct according to claim 12, wherein at least one of the following varies along the span of the splitter vane:
the camber;
the chord length;
the axial leading edge position;
the axial trailing edge position;
the thickness;
the distance of the leading edge from the hub;
the distance of the trailing edge from the hub;
the thickness.

14. A gas turbine engine duct according to claim 1, wherein the leading edge of the splitter vane has a waved and/or serrated shape and/or the trailing edge of the splitter vane has a waved and/or serrated shape.

15. A gas turbine engine duct according to claim 1, wherein the splitter vane extends continuously across the full passage between the neighbouring stator vanes in a substantially circumferential direction.

16. A gas turbine engine comprising:
a fan stage; and
an engine core downstream of the fan stage, the engine core comprising the gas turbine engine duct according to claim 1, wherein:
the plurality of circumferentially spaced stator vanes are provided immediately downstream of the fan stage.

17. A gas turbine engine according to claim 16, wherein the circumferentially spaced stator vanes are immediately upstream of circumferentially spaced guide vanes.

18. A gas turbine engine according to claim 17, wherein the circumferentially spaced non-rotating guide vanes are variable inlet guide vanes that are immediately upstream of a rotor stage.
